(19) United States
(12) Patent Application Publication
(10) Pub. No.: US 2016/0298584 A1
(43) Pub. Date: Oct. 13, 2016

(54) Ducted Combustion Systems Utilizing Outside Air Injection

(71) Applicant: CATERPILLAR INC., Peoria, IL (US)

(72) Inventors: Kenth Svensson, Peoria, IL (US); Christopher Gehrke, Chillicothe, IL (US); Jonathan Anders, Peoria, IL (US); Chad Koci, Washington, IL (US); Timothy Bazyn, Chillicothe, IL (US)

(73) Assignee: CATERPILLAR INC., Peoria, IL (US)

(21) Appl. No.: 14/685,195

(22) Filed: Apr. 13, 2015

(51) Int. Cl. F02M 55/00

(52) U.S. Cl. CPC F02M 55/008

(57) ABSTRACT

A ducted combustion system is disclosed. The ducted combustion system includes a combustion chamber bound by a flame deck surface of a cylinder head of an internal combustion engine and by a piston top surface of a piston disposed within the internal combustion engine. The system includes a fuel injector including at least one orifice, the at least one orifice injecting fuel into the combustion chamber as at least one fuel jet. The system includes at least one duct disposed within the combustion chamber between the flame deck surface and the piston top surface. The system includes an air injector configured to receive air from an outside source, independent of the combustion chamber, and inject the air into the combustion chamber proximate to the at least one duct.

### TECHNICAL FIELD

The present disclosure generally relates to internal combustion engines and, more particularly, relates to ducted combustion systems for internal combustion engines.

### BACKGROUND

Modern combustion engines may include one or more cylinders as part of the engine. The cylinder and an associated piston may define a combustion chamber therebetween. Within the combustion chamber, fuel for combustion is directly injected into the combustion chamber by, for example, a fuel injector, which is associated with the cylinder and has an orifice disposed such that it can directly inject fuel into the combustion chamber.

Different mixtures and/or equivalence ratios of the fuel/air mixture within the fuel jet may produce different results during combustion. The manners in which the injected fuel mixes and/or interacts with the air and other environmental elements of the combustion chamber may impact combustion processes and associated emissions. Further, if the fuel and air mixing is inadequate, then suboptimal or abnormally large amounts of soot may form within the combustion chamber.

To aid in preventing or reducing soot formation and to increase efficiency in such combustion engines, systems and methods for ducted combustion have been developed. For example, U.S. Patent Publication No. 2012/0186555 (“Ducted Combustion Chamber for Direct Injection Engines and Method”) discloses ducted combustion within a combustion engine. The ducts of the '555 application generally include fins disposed around a fuel jet injected by a fuel injector. Such ducts may form a passageway corresponding to an orifice of the fuel injector, into which fuel jets are injected. The fuel jets may be channeled into the ducts, which may improve fuel combustion because upstream regions of a direct-injected fuel jet may be affected by faster and more uniform mixing as well as by an inhibition or reduction of entrainment of combustion products from downstream regions of the same or neighboring jets.

While the teachings of the '555 application are advantageous in providing an improved fuel/air mixture, further improvements in fuel/air mixtures are always desired, as such improvements may further reduce emissions and soot formation. Therefore, systems and methods for ducted combustion that include outside air injection, for improving fuel/air mixtures, are desired.

### SUMMARY

In accordance with one aspect of the disclosure, a ducted combustion system is disclosed. The ducted combustion system may include a combustion chamber, which is defined as an enclosure bound at a first end by a flame deck surface of a cylinder head of an internal combustion engine and bound at a second end by a piston top surface of a piston disposed within the internal combustion engine. The system may further include a fuel injector in fluid connection with the combustion chamber and including at least one orifice opening from an injector tip of the fuel injector, the at least one orifice injecting fuel into the combustion chamber as at least one fuel jet. The system may further include at least one duct disposed within the combustion chamber between the flame deck surface and the piston top surface, the at least one duct being disposed such that at least one fuel jet, at least partially, enters one of the at least one duct upon being injected into the combustion chamber. The system may further include an air injector configured to receive air from an outside source, independent of the combustion chamber, and inject the air into the combustion chamber proximate to the at least one duct.

In accordance with another aspect of the disclosure, an internal combustion engine is disclosed. The internal combustion engine may include an engine block having at least one cylinder bore. The internal combustion engine may further include a cylinder head having a flame deck surface disposed at one end of the cylinder bore. The internal combustion engine may further include a piston connected to a crankshaft and configured to reciprocate within the cylinder bore, the piston having a piston top surface facing the flame deck surface such that a combustion chamber is defined within the cylinder bore bound at a first end by the flame deck surface and at a second end by the piston top surface. The internal combustion engine may further include a fuel injector in fluid connection with the combustion chamber and including at least one orifice opening from an injector tip of the fuel injector, the at least one orifice injecting fuel into the combustion chamber as at least one fuel jet. The internal combustion engine may further include at least one duct disposed within the combustion chamber between the flame deck surface and the piston top surface, the at least one duct being disposed such that at least one fuel jet, at least partially, enters one of the at least one duct upon being injected into the combustion chamber. The internal combustion engine may further include an air injector configured to receive air from an outside source, independent of the combustion chamber, and inject the air into the combustion chamber proximate to the at least one duct.

In accordance with yet another aspect of the disclosure, a method for operating a combustion system is disclosed. The method may include injecting a fuel jet into a combustion chamber of an internal combustion engine, the combustion chamber defined as an enclosure bound at a first end by a flame deck of a cylinder of an internal combustion engine, and bound at a second end by a piston top surface of a piston disposed within the internal combustion engine. The method may further include receiving air from an outside source and injecting the air from the outside source into the combustion chamber, proximate to a duct. The method may further include directing the fuel jet, at least partially, into the duct to provide a substantially uniform mixture of fuel and air within the combustion chamber.

Other features and advantages of the disclosed systems and principles will become apparent from reading the following detailed disclosure in conjunction with the included drawing figures.

### BRIEF DESCRIPTION OF THE DRAWINGS

FIG. 1 is a side cross-sectional view of an internal combustion engine, in accordance with an embodiment of the present disclosure.

FIG. 2 is a front, cross-sectional view of a cylinder of the internal combustion engine of FIG. 1, as shown taken from the reference notation “A” of FIG. 1, in accordance with the present disclosure.

FIG. 3 is a side view of ducts and an air injector for use within the cylinder(s) of FIGS. 1 and 2, in accordance with an embodiment of the disclosure.

FIG. 4 is a side view of two cylinders of the internal combustion engine of FIG. 1, wherein a second cylinder provides air to a first cylinder via an air injector, in accordance with an embodiment of the disclosure.

FIG. 5 is a side view of ducts and an air injector for use within the cylinder(s) of FIGS. 1 and 2, wherein the air injector receives air from an air compressor, in accordance with an embodiment of the disclosure.

FIG. 6 is a block diagram of a flowchart representative of a method for operating a combustion system, in accordance with an embodiment of the disclosure.

FIG. 7 is a block diagram of a flowchart representative for a method for providing outside air to a combustion chamber, in conjunction with the method of FIG. 6 and in accordance with an embodiment of the disclosure.

While the following detailed description will be given with respect to certain illustrative embodiments, it should be understood that the drawings are not necessarily to scale and the disclosed embodiments are sometimes illustrated diagrammatically and in partial views. In addition, in certain instances, details which are not necessary for an understanding of the disclosed subject matter or which render other details too difficult to perceive may have been omitted. It should therefore be understood that this disclosure is not limited to the particular embodiments disclosed and illustrated herein, but rather to a fair reading of the entire disclosure and claims, as well as any equivalents thereto.

### DETAILED DESCRIPTION

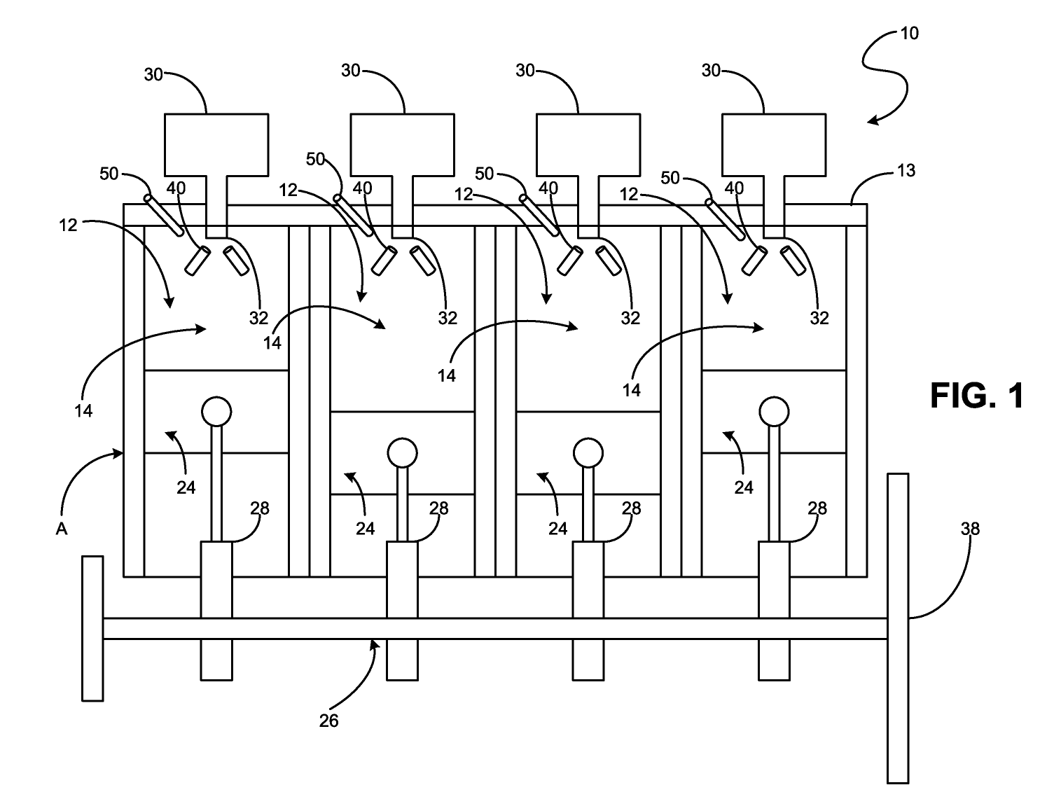

Turning now to the drawings and with specific reference to FIG. 1, a combustion engine 10 is shown. The engine 10 may be an internal combustion engine having a plurality of cylinders 12. For example, the cylinders 12 may be defined as cylinder bores within an engine block 13 of the engine 10. Each of the plurality of cylinders 12 includes a combustion chamber 14. Each combustion chamber 14 may have a generally cylindrical shape, in accordance with the general shape of the cylinder 12.

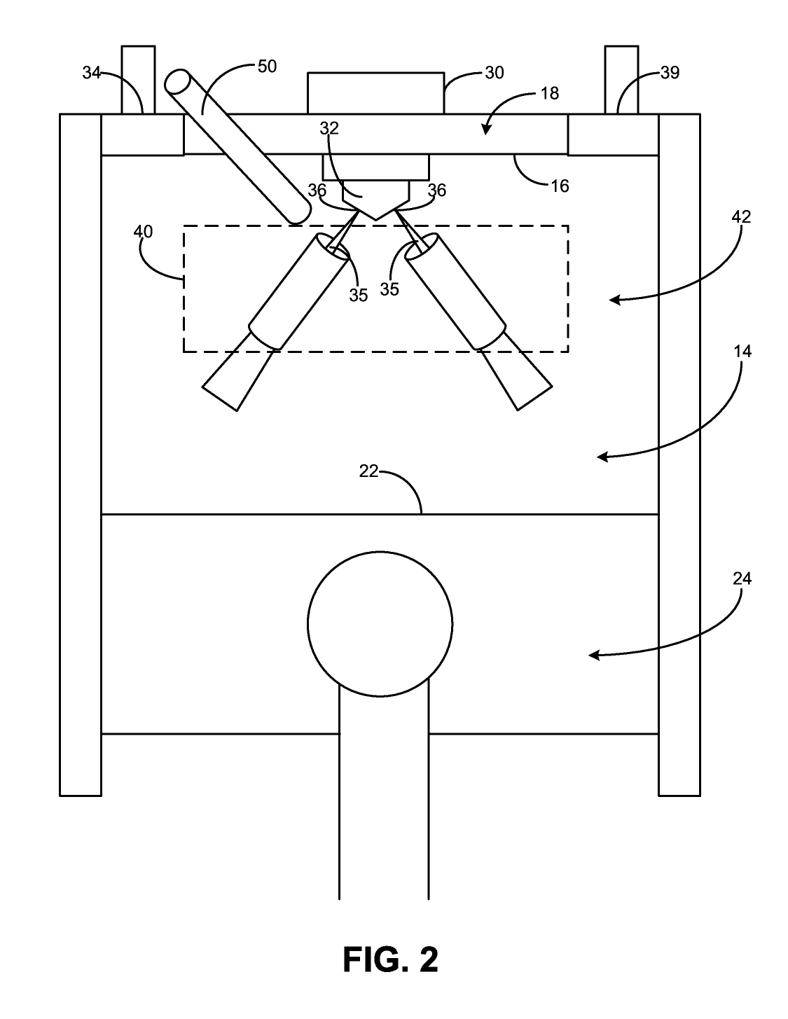

The combustion chamber 14 is shown in greater detail in the front, cross-sectional view of FIG. 2. As shown in FIG. 2, and with continued reference to FIG. 1, the combustion chamber 14 may be bound at one end by a flame deck surface 16 of a cylinder head 18 of each cylinder 12. The combustion chamber 14 may be further bound at a second end by a piston top surface 22 of a piston 24. The piston 24 is reciprocally disposed within the bore and, as shown in FIG. 1, is connected to a crankshaft 26 via a connecting rod 28. A fuel injector 30 is in fluid connection with the combustion chamber 14 and may be mounted in the cylinder head 18. The fuel injector 30 includes a tip 32 that protrudes within the combustion chamber 14 through the flame deck surface 16. Therefore, the fuel injector 30, via the tip 32, can directly inject fuel into the combustion chamber 14 as, for example, one or more fuel jets.

During operation of the engine 10, air enters the combustion chamber 14 via one or more air intake valves 34 (shown in FIG. 2). Air is able to enter the combustion chamber 14 when the air intake valves 34 are open during an intake stroke and/or at the end of an exhaust stroke and/or at the beginning of a compression stroke. When air is present in the combustion chamber 14, the fuel injector 30, via the tip 32, will inject high pressure fuel through orifices 36 of the tip 32 as fuel jets 35. The fuel jets 35 may generally disperse within the combustion chamber 14 to create a fuel/air mixture within the combustion chamber 14. Ignition produces combustion, which, in turn, provides work on the piston 24 to produce motion upon the crankshaft 26 to drive an output 38. Following combustion, exhaust gas may be expelled from the combustion chamber 14 via one or more exhaust valves 39, when said exhaust valves 39 may be open during an exhaust stroke and/or at the end of a power stroke and/or at the beginning of an intake stroke of the engine 10.

Within the combustion chamber 14, uniformity of fuel/air mixture may be relevant to the combustion efficiency and may be relevant to the amount and type of combustion byproducts that are formed. For example, if the fuel/air mixture is too rich in fuel due to insufficient mixing within the combustion chamber 14, then higher soot emissions may occur within the combustion chamber 14 and/or combustion efficiency may be affected. However, using one or more ducts 40 disposed within the combustion chamber 14 may provide for more uniform fuel/air mixing within the fuel jets 35. Using such, the one or more ducts 40, a lift-off length of a flame associated with a fuel jet 35 may be altered (extended or reduced) to achieve an optimized lift-off length. The one or more ducts 40 may alter lift-off length due to energy exchange between the one or more ducts 40 and the fuel/air mixture of the fuel jet 35, due to altering fluid dynamics of the fuel/air mixture of the fuel jet 35, and/or due to prevention of lift-off length recession by acting as a flame arrester.

The one or more ducts 40 may be disposed within a flame region 42 of the combustion chamber 14. The flame region 42 may be defined as a region of the combustion chamber 14 extending from the flame deck surface 16 to the piston top surface 22, when the piston 24 is at or close to a maximum compression distance or top dead center (TDC) position.

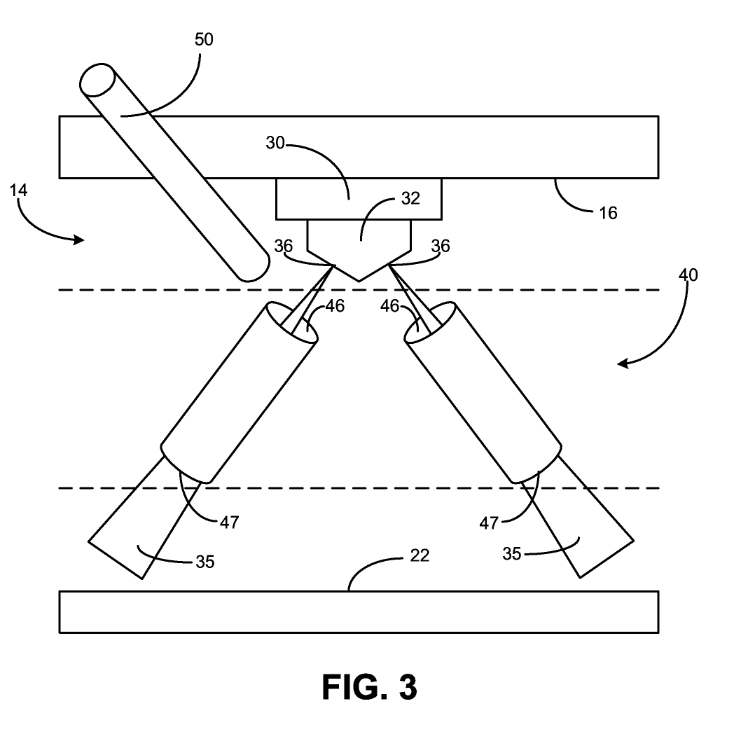

To further illustrate the one or more ducts 40 and their interaction with one or more fuel jets 35 injected from the one or more orifices 36 of the tip 32 of the fuel injector 30, the ducts 40, within the combustion chamber 14, are shown in greater detail in FIG. 3. While the one or more ducts 40 are shown herein as generally tubular shaped structures, the one or more ducts 40 may be any plurality of structures or single structures defining any shape of duct with which the one or more fuel jets 35 may pass through upon injection. Upon being injected out of the one or more orifices 36, the fuel jets 35 may, at least partially, enter the ducts 40 at duct openings 46 and may, at least partially, flow through the ducts 40 to duct outlets 47. In some examples, the ducts 40 may be positioned and/or supported within the combustion chamber 14 by a support structure. The support structure may be any mounting, wiring, or other positioning device suitable for positioning the ducts 40 within the combustion chamber 14.

Use of the ducts 40 may provide improved mixing of a fuel/air mixture within the fuel jets 35. The ducts 40 may direct combustion away from the fuel injector 30, such that longer flame lift-off lengths may be achieved. Further, by channeling the fuel jets 35 into the ducts 40 may inhibit or reduce entrainment of combustion products from downstream regions of the same or neighboring fuel jets 35. By using such ducts 40, levels of soot within the combustion chamber 14, which often result from inadequate fuel/air mixtures, may be reduced greatly.

To provide further air/fuel mixing in or around the ducts 40 and/or the fuel jets 35 and as shown in FIGS. 2 and 3, an air injector 50 may be provided. The air injector 50 may be configured to receive air from an outside source, which may be any air source independent of the combustion chamber 14. Air, as defined herein, may be any combination of oxygen-containing gases and other airborne products, such as combustion products. In some examples, the outside air may have a cooler temperature, which may aid in cooling within and/or in the proximity of the ducts 40. The air injector 50 may then inject said air from an outside source into the combustion chamber 14, proximate to at least one of the one or more ducts 40. In some examples, the air injector 50 may be specifically configured to inject said air proximate to the opening 46 of at least one of the one or more ducts 40.

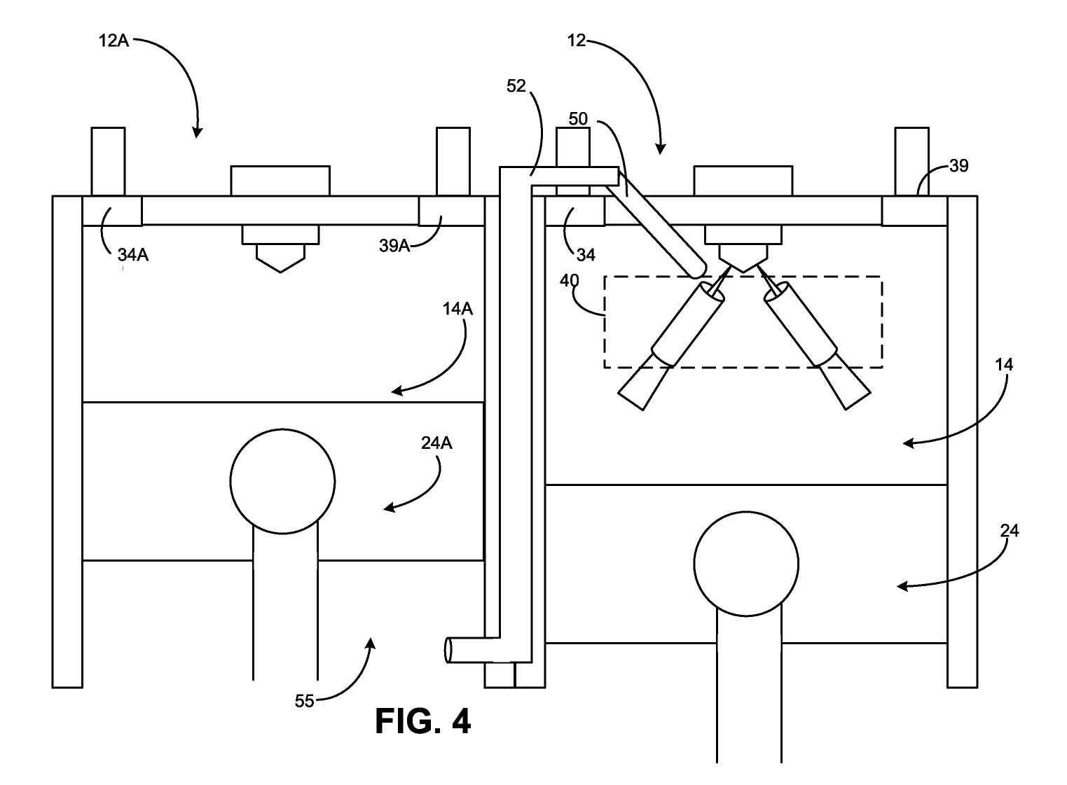

As mentioned above, the outside source from which the air injector 50 receives the air may be any source of air independent of the combustion chamber 14. For example, as shown in FIG. 4, the cylinder 12, in which the ducts 40 are disposed and the air injector 50 injects air, may be paired with a second cylinder 12A of the internal combustion engine 10. Similar to the first cylinder 12, the second cylinder 12A may be a cylinder bore of the engine block 13. The air injector 50 may be connected to the second cylinder 12A via an air conduit 52 from which the air injector 50 may draw air.

In some examples, the air conduit 52 may be connected to piston cavity 55, located underneath a second piston 24A of the second cylinder 12A, wherein air enters the air conduit 52 from the piston cavity 55 and continues to flow to the air injector 50. In such examples, the air injector 50 may receive air via the air conduit 52 when the second piston 24A is in reciprocating motion. For example, when the piston 24A is in reciprocating motion, air from the piston cavity 55 may be compressed and, thus, forced into the air conduit 52 and, thereby, injected into the chamber 14 via the air injector 50.

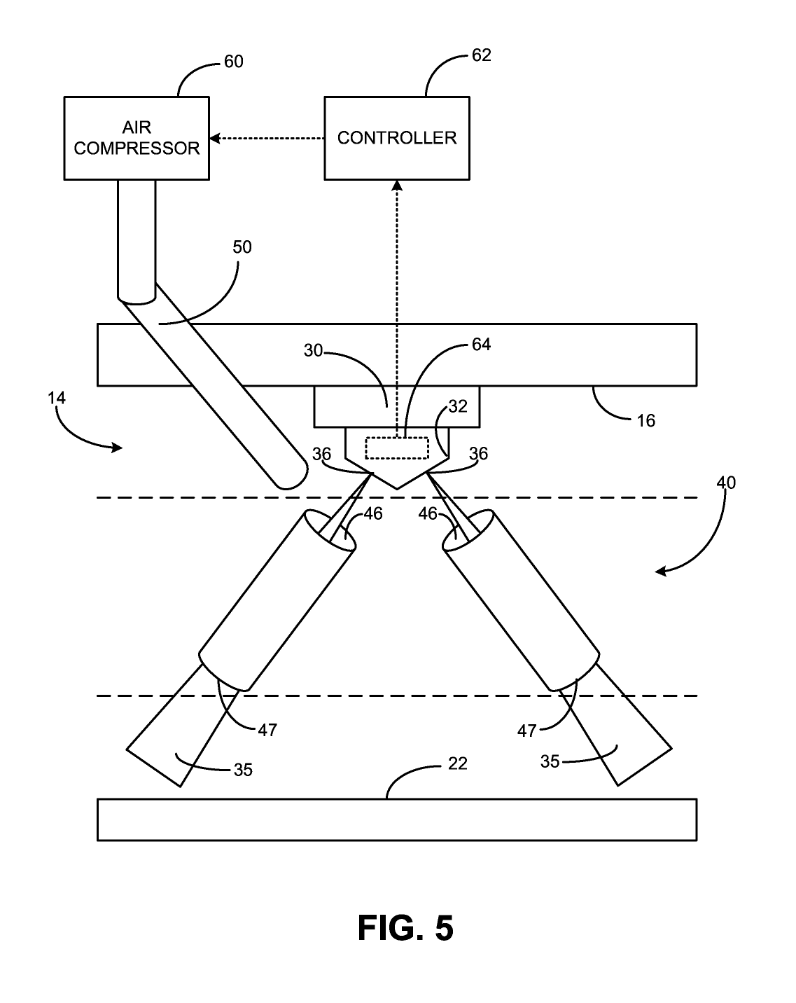

In an alternative embodiment shown in FIG. 5, the outside source of air may come from an air compressor 60. The air compressor 60 may be any electrical or mechanical device that provides air to the air injector 50. Levels of outside air provided by the air compressor 60 and/or the timing of injection of said air may be controlled by a controller 62 associated with the air compressor 60 and any other elements of the internal combustion engine 10 or its cylinders 12. The controller 62 may be any electronic controller or computing system including a processor which operates to perform operations, execute control algorithms, store data, retrieve data, gather data, and/or any other computing or controlling task desired. The controller 62 may be configured to provide control signals to the air compressor 60 to control the injection of air into the combustion chamber 14 via the air injector 50.

In some examples, the controller may be associated with a flow sensor 64. The control signals for the air compressor 60 may be determined using information provided to the controller 62 using the flow sensor 64. The information provided by the flow sensor 64 may include, but is not limited to including, flow rate of the fuel jets 35, fuel pressure output from the fuel injector 31, fuel velocity of the fuel jets 35, injection timing of one or more of the fuel jets 35, and any other information associated with flow of fuel from the fuel injector 31. The controller 62 may use flow signals provided by the flow sensor 64 to determine the control signals provided to the air compressor 60 to control injection of air via the air injector 50.

### INDUSTRIAL APPLICABILITY

The present disclosure relates generally to internal combustion engines and, more specifically, to ducted combustion systems. While the present disclosure shows the embodiments as related to internal combustion engines having reciprocating pistons, the teachings of the disclosure are certainly applicable to other combustion systems, which utilize diffusion or non-premixed flames, such as gas turbines, industrial burners, and the like. As discussed above, the various arrangements of ducts and their related elements are useful in promoting a substantially uniform fuel/air mixture within combustion chambers and may inhibit or reduce entrainment of recirculated combustion products from downstream regions into upstream regions of fuel jets injected into combustion chambers. However, using such systems and methods for ducted combustion may also decrease fuel/air mixing, while reducing equivalence ratio at the lift-off length.

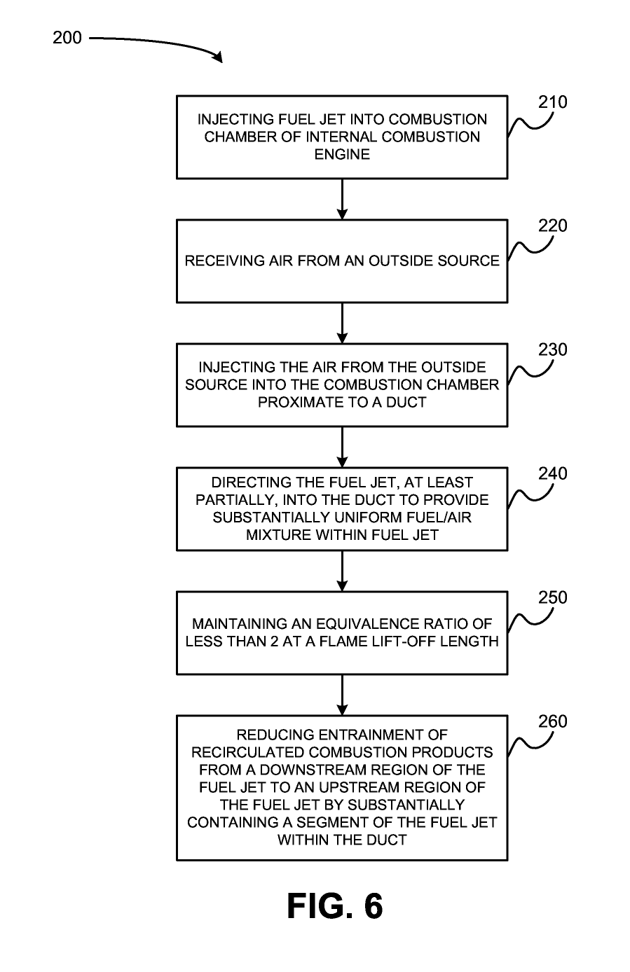

An example method utilizing the ducted combustion systems shown in FIGS. 1-5 and described above is exemplified in the flowchart of FIG. 6, which represents a method 200 for operating a combustion system. The method 200 begins at block 210, by injecting a fuel jet 35 into the combustion chamber 14 of the internal combustion engine 10.

For further mixing of air and fuel within the fuel jets 35, the method may include receiving air from an outside source (block 220) and injecting said air from the outside source into the combustion chamber 14 proximate to a duct 40 (block 230). The outside source from which the air is drawn may be, but is not limited to being, a second cylinder 12A of the internal combustion engine 10 (FIG. 4) or an air compressor 60 (FIG. 5).

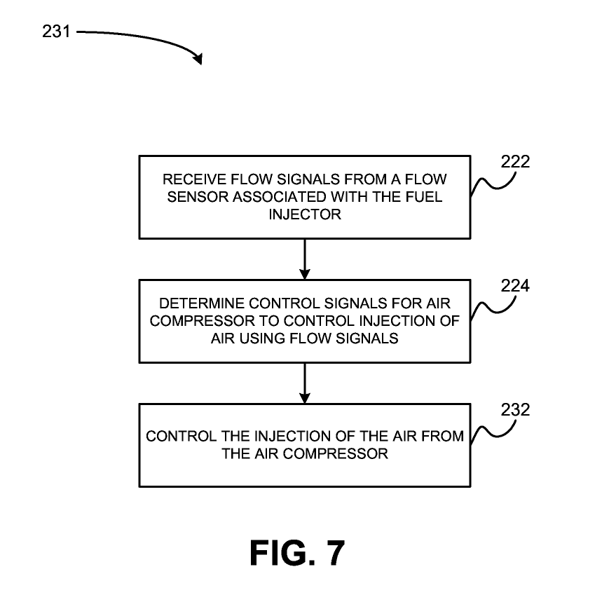

In such examples wherein the outside source is an air compressor 60, the method 231 for providing outside air to a combustion chamber shown in FIG. 7 may be employed in conjunction with the method 200 of FIG. 6. The method 231 begins when the controller 62 receives flow signals from the flow sensor 64 associated with the fuel injector 30, as shown in block 222. The controller 62 then determines control signals for the air compressor 60 to control injection of air via the air injector 50, as shown in block 224. Air injection is then controlled by using the air compressor 60 based on the control signals.

Returning now to FIG. 6, the fuel jet 35 may be directed into a duct of the one or more ducts 40, to provide a substantially uniform fuel/air mixture within the fuel jets, as shown in block 240.

The disclosed ducted combustion systems may be configured to use the one or more ducts 40 to direct combustion away from the fuel injector tip 32, so that the equivalence ratio at the flame lift-off length, produced during combustion, is lower. Using the one or more ducts 40, greater uniformity of equivalence ratio within the fuel jets 35 may be achieved. Maintaining a reduced equivalence ratio at the lift-off length may reduce soot formation. Achieving a reduced equivalence ratio at the lift-off length may be accomplished by altering the lift-off length, when employing any of the aspects of the present application. Alterations to the lift-off length may occur if heat is transferred from the fuel/air mixture of the fuel jets 35 to the duct structure 40. Additionally or alternatively, alterations to the lift-off length may be achieved by alteration of fuel jet fluid dynamics, which are resultant of characteristics of the ducts 45. Further, use of ducts 45 may prevent lift-off length recession by acting as a flame arrester.

Substantially soot-free combustion may be achieved if the equivalence ratio at the flame lift-off length is less than two. Therefore, at block 250, the method 200 may include maintaining an equivalence ratio of less than two at the flame lift-off length

At block 260, the method 200 may reduce entrainment of recirculated combustion products from a downstream region of the fuel jet 35 to an upstream region of the fuel jet 35 by substantially containing a segment of the fuel jet 35 within a duct 40. Reducing such entrainment may lead to an overall reduction in soot production within the combustion chamber 14 and may lead to greater overall efficiency of the internal combustion engine 10. Presence of ducts 40 may alter amount and position of entrainment of recirculated combustion products, within the fuel jets 35

It will be appreciated that the present disclosure provides ducted combustion systems, internal combustion engines utilizing ducted combustion, and methods for operating combustion systems utilizing ducted combustion. While only certain embodiments have been set forth, alternatives and modifications will be apparent from the above description to those skilled in the art. These and other alternatives are considered equivalents and within the spirit and scope of this disclosure and the appended claims.

What is claimed is:

1. A ducted combustion system, comprising:
a combustion chamber defined as an enclosure bound at a first end by a flame deck surface of a cylinder head of an internal combustion engine, and bound at a second end by a piston top surface of a piston disposed within the internal combustion engine;
a fuel injector in fluid connection with the combustion chamber and including at least one orifice opening from an injector tip of the fuel injector, the at least one orifice injecting fuel into the combustion chamber as at least one fuel jet;
at least one duct disposed within the combustion chamber between the flame deck surface and the piston top surface, the at least one duct being disposed such that the at least one fuel jet, at least partially, enters the at least one duct upon being injected into the combustion chamber; and
an air injector configured to receive air from an outside source, independent of the combustion chamber, and inject the air into the combustion chamber proximate to the at least one duct.

2. The ducted combustion system of claim 1, wherein the at least one duct has an opening proximate to a first end and the air injector is configured to inject the air into the combustion chamber proximate to the opening.

3. The ducted combustion system of claim 1, wherein the outside source is a second cylinder disposed within the internal combustion engine.

4. The ducted combustion system of claim 1, wherein the outside source is an air compressor configured to provide the air to the air injector.

5. The ducted combustion system of claim 4, further comprising a controller, the controller associated with the air compressor and providing control signals to the air compressor to control injection of air via the air injector.

6. The ducted combustion system of claim 5, further comprising a flow sensor associated with the fuel injector, the controller using flow signals provided by the flow sensor to determine the control signals provided to the air compressor to control injection of air via the air injector.

7. An internal combustion engine, comprising:
an engine block including a first cylinder bore;
a cylinder head having a flame deck surface disposed at one end of the first cylinder bore;
a piston connected to a crankshaft and configured to reciprocate within the first cylinder bore, the piston having a piston top surface facing the flame deck surface such that a combustion chamber is defined within the first cylinder bore bound at a first end by the flame deck surface and at a second end by the piston top surface;
a fuel injector in fluid connection with the combustion chamber and including at least one orifice opening from an injector tip of the fuel injector, the at least one orifice injecting fuel into the combustion chamber at least one fuel jet;
at least one duct disposed within the combustion chamber between the flame deck surface and the piston top surface, the at least one duct being disposed such that the at least one fuel jet, at least partially, enters the at least one duct upon being injected into the combustion chamber; and
an air injector configured to receive air from an outside source, independent of the combustion chamber, and inject the air into the combustion chamber proximate to the at least one duct.

8. The internal combustion engine of claim 7, wherein the at least one duct has an opening proximate to a first end and the air injector is configured to inject the air into the combustion chamber proximate to the opening.

9. The internal combustion engine of claim 7, wherein the engine block includes a second cylinder bore having a second piston, and the outside source is a piston cavity within the second cylinder bore and underneath the second piston.

10. The internal combustion engine of claim 9, wherein the air injector is connected to the piston cavity, and
wherein the air enters the air injector via an air conduit associated with the piston cavity and the air injector, when the second piston is in reciprocating motion.

11. The internal combustion engine of claim 7, wherein the outside source is an air compressor configured to provide the air to the air injector.

12. The internal combustion engine of claim 11, further comprising a controller, the controller associated with the air compressor and providing control signals to the air compressor to control injection of air via the air injector.

13. The internal combustion engine of claim 12, further comprising a flow sensor associated with the fuel injector, the controller using flow signals provided by the flow sensor to determine the control signals provided to the air compressor to control injection of air via the air injector.

14. A method for operating a combustion system, comprising:
injecting a fuel jet into a combustion chamber of an internal combustion engine, the combustion chamber defined as an enclosure bound at a first end by a flame deck of a cylinder of an internal combustion engine, and bound at a second end by a piston top surface of a piston disposed within the internal combustion engine;
receiving air from an outside source independent of the combustion chamber;
injecting the air from the outside source into the combustion chamber, proximate to a duct; and
directing the fuel jet, at least partially, into the duct to provide a substantially uniform mixture of fuel and air within the combustion chamber.

15. The method of claim 14, wherein injecting the air from the outside source into the combustion chamber proximate to the duct includes injecting the air proximate to an opening of the duct.

16. The method of claim 14, wherein receiving air from the outside source includes receiving air from a piston cavity disposed underneath a second piston and within the internal combustion engine.

17. The method of claim 16, wherein receiving air from the outside source includes receiving air via an air conduit associated with the piston cavity, when the second piston is in reciprocating motion.

18. The method of claim 14, wherein receiving air from the outside source includes receiving air from an air compressor.

19. The method of claim 18, further comprising controlling the injecting of the air from the air compressor by utilizing a controller providing control signals to the air compressor.

20. The method of claim 19, further comprising receiving, by the controller, flow signals from a flow sensor associated with the internal combustion engine, the controller; and
determining the control signals provided to the air compressor to control injection of air by using the flow signals.
